(19) United States
(12) Patent Application Publication
(10) Pub. No.: US 2026/0138819 A1
(43) Pub. Date: May 21, 2026

(54) COMPACTOR ASSEMBLIES FOR REFUSE CONTAINERS

(71) Applicant: Wastequip LLC, Charlotte, NC (US)

(72) Inventors: Stratton Konstantine Bacogeorge, Charlotte, NC (US); Ashton Cole Franiak, Charlotte, NC (US); Nicholas Stephen Franiak, Charlotte, NC (US); Richard Thomas Sedory, Charlotte, NC (US)

(21) Appl. No.: 19/392,450

(22) Filed: Nov. 18, 2025

Related U.S. Application Data
(60) Provisional application No. 63/722,277, filed on Nov. 19, 2024.

(51) Int. Cl. B65F 1/14

(52) U.S. Cl. CPC B65F 1/1405

(57) ABSTRACT

An assembly for compacting material disposed within an open-topped container is provided including a roller compactor coupled with an arm. The roller compactor is positionable relative to the open-topped container between a first vertical position and a second vertical position. The assembly includes a frame coupled with the arm. The frame comprises a first and second posts disposed on opposing lateral sides of the roller compactor. The first and second posts each define proximal and distal ends. First and second shoes of the assembly are pivotably coupled with the distal end of the first and second posts. The shoes each define slots sized for sliding engagement with a top rail of the open-topped container. The assembly includes cross-member(s) extending between each post and the arm. The cross members are movable relative to the posts in response to movement of the roller compactor between the first and second vertical positions.

### CROSS-REFERENCE TO RELATED APPLICATIONS

The present application claims the benefit of U.S. Provisional App. Ser. No. 63/722,277, filed Nov. 19, 2024, entitled “Compactor Assemblies for Refuse Containers,” which is incorporated by reference herein in their entireties for all purposes.

### FIELD

Embodiments of the present invention relate generally to the field of material-hauling containers and compactors for compacting refuse and other material disposed therewithin. More particularly, certain embodiments relate to mobile or vehicle-mounted compactor assemblies that are not attached to the container in which refuse or other material is to be compacted.

### BACKGROUND

In the waste and materials hauling industry, a variety of containers are used to collect, transport, and/or dump waste, bulk, and liquid materials, among others. Such containers typically are carried on vehicles, such as trucks, or on trailers. The vehicle or trailer is provided with a hoist apparatus to load a container onto and unload the container from the vehicle or trailer, transport the container, and empty the container. Examples of hoist apparatuses include hook hoists, cable hoists, winches, forklifts, and container handlers. The containers loaded and carried by hoist apparatuses may be very heavy, especially when filled. Accordingly, and for example, hoist apparatuses may be rated for a container capacity of 20,000 or 30,000 lbs. Heavier duty hoist apparatuses can be rated for more than 30,000 lbs., in some cases up to 75,000 lbs. or greater.

One type of refuse container is known as a “roll-off container.” Roll-off containers can be used in a variety of demanding waste applications, including scrap collection, construction and remodeling, demolition, and industrial clean-up, among others. Roll-off containers typically have an open top and a plurality of sidewalls (which may or may not include a door) and a bottom wall that together define an interior volume. Such containers are usually designated by the volume of material they can contain, such as 10, 20, 30, or 40 cubic yards. Roll-off containers are currently available from a number of companies, such as Wastequip, LLC of Charlotte, North Carolina. Two common types of roll-off containers are rectangular, open top roll-offs and “tub-style” roll offs. The latter style of roll-off container has smooth sides and may be stackable for transporting and storage. Additional information regarding roll-off containers is provided in commonly-owned U.S. Pat. No. 12,098,024, entitled “Refuse Container Having Modular Side Walls,” the entire disclosure of which is incorporated by reference herein for all purposes.

When refuse containers such as roll-off containers are filled with material, the material is often loaded without the material being densely packed. This limits the amount of material that may be held within the refuse container and may result in more frequent emptying of the container than is otherwise required. Various systems are known for compacting material in refuse containers, but these systems suffer from several drawbacks. For instance, some systems must be directly connected to the containers themselves and may have limited degrees of freedom of movement. Other systems that are not directly connected to the containers can damage the containers due to contact between the compaction mechanism and the container sidewalls or due to over-compaction of the material in the refuse container.

The foregoing discussion is intended only to illustrate various aspects of the related art in the field of the invention at the time, and should not be taken as a disavowal of claim scope.

### BRIEF SUMMARY

Embodiments of the present invention guide the movement of compaction devices, such as roller compactors, and associated arms that may carry the compaction devices. Thus, embodiments of the present invention may help to ensure that the compaction devices are positioned appropriately relative to the top rails and/or side walls of various types of refuse containers. Embodiments of the present invention may protect against the formation of cracks in or other failure modes of the refuse containers, in that they can reduce the likelihood of direct collisions between a compaction device and/or its associated carrying arm and a refuse container.

Embodiments of the present invention also allow movement of a compacting device not only vertically into and out of a container, but also at an angle to a horizontal plane. For example, embodiments may comprise a frame assembly comprising one or more posts that are pivotable relative to the container or relative to shoes attached at the distal ends of the posts. The shoes can contact a top rail of the refuse container, for example, and slide horizontally therealong.

Certain embodiments also may assist in preventing over-compaction. For example, stops can be included on posts of the frame assemblies, preventing compaction devices from being lowered past a certain point. Also, in various embodiments, compacting device frame assemblies may be retrofittable for use with existing compacting devices and carrying arms. Further, in certain embodiments, a compacting device frame assembly can be adjustable for use with refuse containers of different volumes or widths and/or for use with compacting devices and associated carrying arms having different sizes or shapes.

In an example embodiment, an assembly for compacting material disposed within an open-topped container is provided. The open-topped container comprises a left side wall, a right side wall, and a pair of top rails respectively extending along the left side wall and the right side wall. The assembly comprises a roller compactor and a frame. The roller compactor is coupled with an arm, and the roller compactor is rotatable about an axis of rotation extending perpendicularly to the left side wall and the right side wall of the open-topped container. The roller compactor may be positioned relative to the open-topped container between a first vertical position located above the pair of top rails and a second vertical position. At the second vertical position, the roller compactor is located at least partially below the pair of top rails and within an interior volume of the open-topped container. The frame is coupled with the arm, and the frame comprises a first post, a second post, a first shoe, a second shoe, at least one first cross-member, and at least one second cross-member. The first post and the second post are disposed on opposing lateral sides of the roller compactor, and the first post and the second post each define a proximal end and a distal end. The first shoe is pivotably coupled with the distal end of the first post, and the second shoe is pivotably coupled with the distal end of the second post. The first shoe and the second shoe each define a slot sized for sliding engagement with a respective top rail of the pair of top rails of the open-topped container. The first cross-member(s) extend between the first post and the arm, and the second cross-member(s) extend between the second post and the arm. The first cross-member(s) and the second cross-member(s) are movable relative to the first post and the second post in response to movement of the roller compactor between the first vertical position and the second vertical position.

In another example embodiment, an assembly for compacting material disposed within an open-topped container is provided. The open-topped container comprises a left side wall, a right side wall, and a pair of top rails respectively extending along the left side wall and right side wall. The assembly comprises a roller compactor, an arm, a pair of masts, and at least one yoke. The roller compactor is coupled with the arm, and the roller compactor is rotatable about an axis of rotation extending perpendicularly to the left side wall and the right side wall of the open-topped container. The masts each define a proximal end and a distal end, and the distal end of each mast is respectively engageable with a top rail of the open-topped container. The yoke(s) are attached to the arm and movably coupled with the masts. In response to movement of the arm, the yoke(s) are translatable along the masts from a position proximate the mast proximal ends to a position proximate the mast distal ends and the masts are pivotable relative to the open-topped container about a pivot axis extending parallel with the axis of rotation.

In another example embodiment, an assembly for compacting material disposed within an open-topped container is provided. The open-topped container comprises a first top rail and a second top rail respectively extending along a pair of laterally opposed side walls of the open-topped container. The assembly comprises a roller compactor, an arm, and a frame assembly. The roller compactor is coupled with the arm, and the roller compactor is rotatable about an axis of rotation extending perpendicularly to the side walls of the open-topped container. The frame assembly is coupled with the arm, and the frame assembly comprises a first support member, a second support member, a first shoe, and a second shoe. The first support member and the second support member both define a proximal end, a distal end, and a longitudinal axis. The first shoe is pivotably coupled with the distal end of the first support member, and the second shoe is pivotably coupled with the distal end of the second support member. The first shoe may be selectively engageable with and slidable along the first top rail of the open-topped container, and the second shoe may be selectively engageable with and slidable along the second top rail of the open-topped container. The first support member may be pivotable relative to the first shoe along a plane intersecting the first shoe and the longitudinal axis of the first support member, and the second support member may be pivotable relative to the second shoe along a plane intersecting the second shoe and the longitudinal axis of the second support member.

In another example embodiment, an assembly for use with a roller compactor for compacting material within an open-topped container is provided. The open-topped container comprises a first top rail and a second top rail respectively extending along a pair of laterally opposed side walls of the open-topped container. The roller compactor is coupled with an arm and is rotatable about an axis of rotation extending perpendicularly to the laterally opposed side walls of the open-topped container. The assembly comprises a first support member, a second support member, a first shoe, and a second shoe. The first and second support members both define a proximal end, a distal end, and a longitudinal axis, and the first and second support members are both attachable to the arm at their proximal ends. The first shoe is pivotably coupled with the distal end of the first support member, and the second shoe is pivotably coupled with the distal end of the second support member. The first shoe and the second shoe each are selectively engageable with a respective first top rail or a second top rail of the open-topped container. The assembly may be configured to operate under certain conditions. These conditions include the first support member and the second support member being attached to the arm, the first shoe being disposed on the first rail of the open-topped container, and the second shoe being disposed on the second top rail of the open-topped container. When the assembly is operated under these conditions and when the arm is moved relative to the open-topped container, the first shoe is slidable along the first top rail, the second shoe is slidable along the second top rail, the first support member is pivotable relative to the first shoe along a first plane intersecting the first top rail and the first support member longitudinal axis, and the second support member is pivotable relative to the second shoe along a second plane intersecting the second top rail and the second support member longitudinal axis.

### BRIEF DESCRIPTION OF THE DRAWINGS

Reference will now be made to the accompanying drawings, which are not necessarily drawn to scale, and wherein:

FIG. 1 is a perspective view of a mobile compactor being used to compact material within an open-topped container;

FIG. 2 is an enlarged view illustrating an example crack formed in an open-topped container due to the use of a mobile compactor similar to the one illustrated in FIG. 1;

FIG. 3A is a perspective view of an example compactor assembly positioned relative to an open-topped container in accordance with some embodiments discussed herein;

FIG. 3B is a top perspective view of the compactor assembly of FIG. 3A;

FIG. 4 is a perspective view of the compactor assembly of FIG. 3A in accordance with some embodiments discussed herein;

FIG. 5A is a perspective view of the frame of the compactor assembly of FIG. 3A positioned on an open-topped container in accordance with some embodiments discussed herein;

FIG. 5B is an enlarged perspective view of a shoe of the compactor assembly of FIG. 3A in accordance with some embodiments discussed herein;

FIG. 5C is a perspective view of example frame members of the compactor assembly of FIG. 3A in accordance with some embodiments discussed herein;

FIGS. 6A and 6B are perspective views of the frame of the compactor assembly of FIG. 3A in accordance with some embodiments discussed herein;

FIG. 6C is an enlarged perspective view illustrating the frame members of the frame of FIG. 6A in accordance with some embodiments discussed herein;

FIG. 7A is a perspective view of an example cross member in the compactor assembly of FIG. 3A in accordance with some embodiments discussed herein;

FIG. 7B is a perspective view of an example adjustable mounting bracket in the assembly of FIG. 3A in accordance with some embodiments discussed herein;

FIG. 8A is an enlarged perspective view of an example shoe pivotably coupled to a post in accordance with some embodiments discussed herein;

FIG. 8B is a top perspective view of the shoe of FIG. 8A in accordance with some embodiments discussed herein;

FIG. 8C is a bottom perspective view of the shoe of FIG. 8A in accordance with some embodiments discussed herein;

FIG. 9A is a perspective view of an example post in the compactor assembly of FIG. 3A in accordance with some embodiments discussed herein;

FIG. 9B is an enlarged perspective view of the post of FIG. 9A in accordance with some embodiments discussed herein;

FIG. 10 is a perspective view of an example carriage in accordance with some embodiments discussed herein;

FIG. 11 is a perspective view of an example carriage bar configured for use with the carriage of FIG. 10 in accordance with some embodiments discussed herein; and

FIG. 12 is a block diagram of a control system for a compactor assembly in accordance with an embodiment of the present invention.

### DETAILED DESCRIPTION

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used herein, terms referring to a direction or a position relative to the orientation of a container or a compactor assembly or component thereof, such as but not limited to “vertical,” “horizontal,” “upper,” “lower,” “front,” or “rear,” refer to directions and relative positions with respect to the apparatus's orientation in its normal intended operation, as indicated in the Figures herein. Thus, for instance, the terms “vertical” and “upper” refer to the vertical direction and relative upper position in the perspectives of the Figures and should be understood in that context, even with respect to an apparatus that may be disposed in a different orientation. The term “substantially,” as used herein, should be interpreted as “nearly” or “close to”, such as to account for design and manufacturing tolerances of the apparatus.

Although some preferred embodiments are discussed below in the context of rectangular, open-topped roll-off containers, those of skill in the art will appreciate that the present invention is not so limited. In particular, it is contemplated that embodiments of the present invention may be used with any suitable waste, refuse, or payload container, such as but not limited to tub-style roll-off containers, intermodal containers, dump bodies, front-end load containers, and rear-end load containers. Further, while certain embodiments are discussed below as used with a roller compactor, it is contemplated that various embodiments may be used with any type of compaction device.

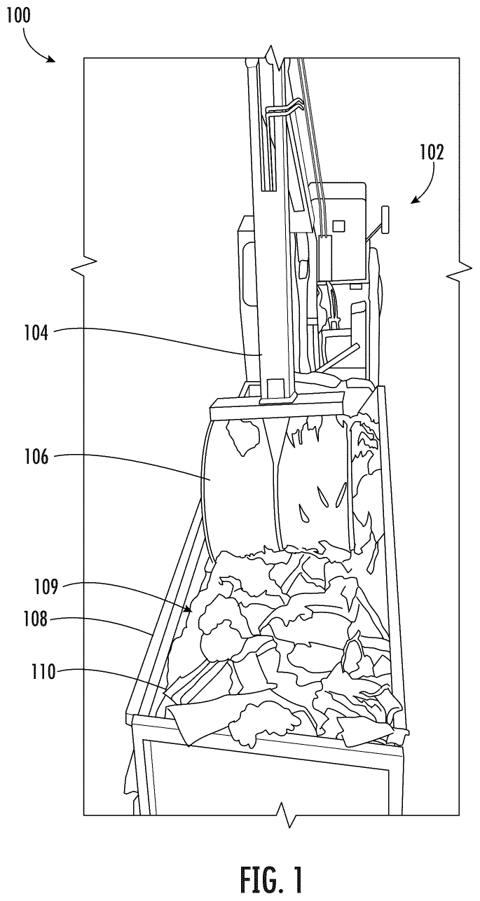

As noted above, mobile compaction units are known for compacting material within open-topped containers. An example of one such mobile compaction unit 100 is illustrated in the perspective view of FIG. 1. The unit 100 of FIG. 1 includes a vehicle 102 having an arm 104 comprising a plurality of articulating segments. Coupled with the arm 104 is a roller compactor 106. The unit 100 is shown adjacent an open-topped container 108 having an internal volume 109 with waste material 110 disposed in the internal volume 109. The arm 104 is used to urge the roller compactor 106 downwardly into the internal volume 109 of the open-topped container 108 so that the roller compactor 106 compacts the waste material 110 therein. By doing so, the waste material 110 may be packed more densely within the internal volume 109, creating more room for additional waste material 110 to be positioned in the internal volume 109. This may enable the open-topped container 108 to be filled to maximum capacity before container 108 is emptied or transported to another location.

The applicant has observed that use of unit 100 can damage the container 108, for example causing cracks or other types of mechanical failures. In this regard, the unit 100 relies upon a human operator to position the roller compactor 106 relative to the walls of the open-topped container 108. When the roller compactor 106 is not appropriately aligned relative to the walls and/or rails of the open-topped container 108, the roller compactor 106 can impact, and thereby damage, the walls and/or rails or other components of container 108. Furthermore, the use of a roller compactor may over compact the material within the container 108, causing bowing of its sidewalls, sometimes to the point of failure.

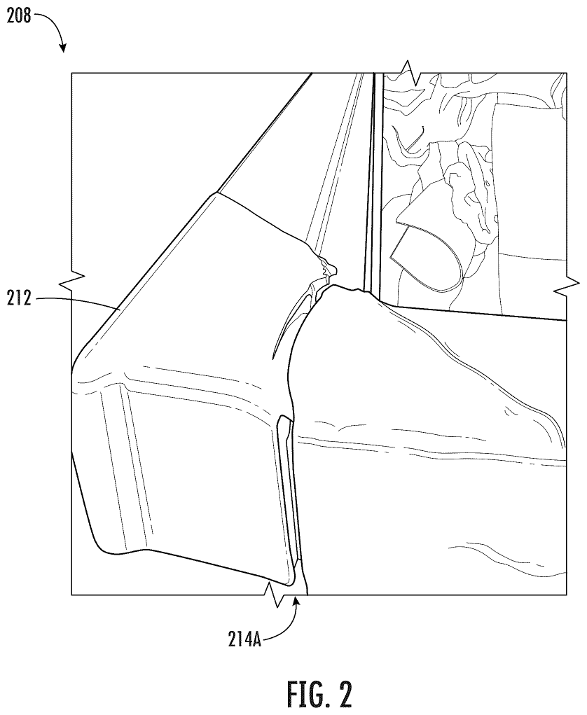

An example of a crack that has been formed in an open-topped container 208 is illustrated in FIG. 2. The crack 214A is formed at the top rail 212 of the open-topped container 208 due to impact forces generated by a roller compactor similar to the roller compactor 106. Similar cracks and other types of failures have been observed at other locations within refuse containers used with mobile compaction units such as unit 100, including at the base, along the walls themselves, at welds, door hooks, hinges, or other small parts, at the ends, and at attachment features of such refuse containers.

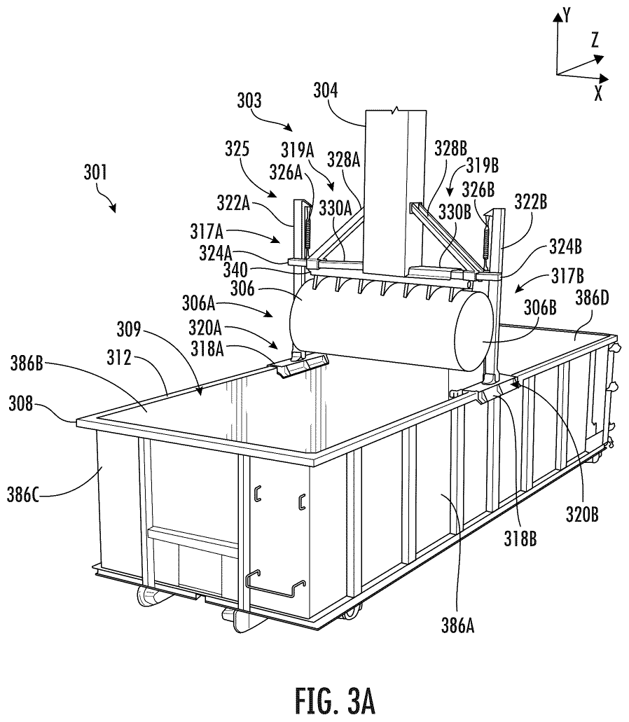

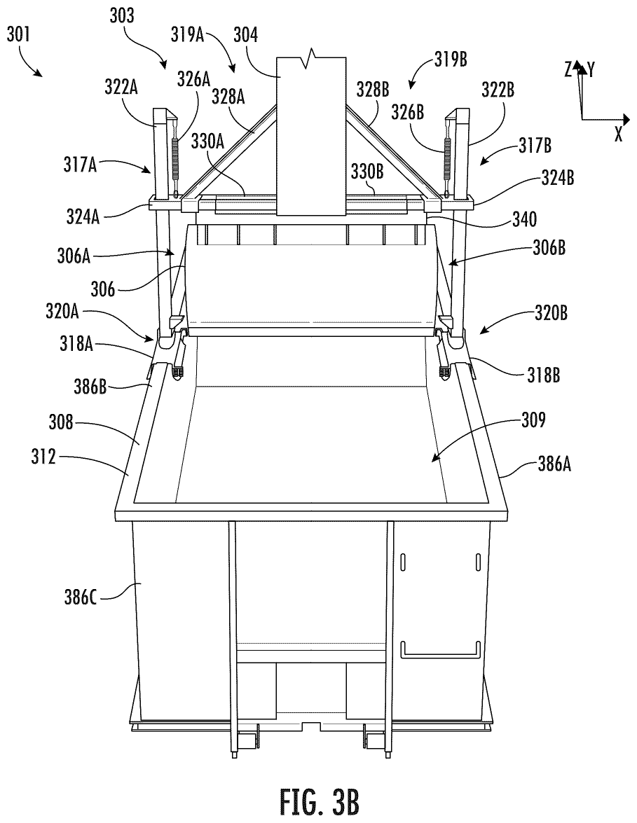

Embodiments of the present invention, in contrast, provide a compactor assembly that can protect refuse containers from excessive forces applied during use of compacting devices, thereby reducing the likelihood of crack formation and other failures. One example of such a compactor assembly is illustrated in the perspective view of FIG. 3A and in the top perspective view of FIG. 3B.

With reference to these figures, a system 301 comprises a compactor assembly 303 configured for use with a refuse container 308, which in this embodiment is an open-topped roll-off container. Refuse container 308 includes a right sidewall 386A, a left sidewall 386B, a first end wall 386C, a second end wall 386D, and a bottom wall. Top rails 312 extend along the top of the right sidewall 386A, the left sidewall 386B, the end wall 386C, and the end wall 386D in this embodiment. As shown, top rails 312 may optionally have an increased cross-sectional size relative to other portions of the walls 386A-386D. The walls 386A-386D and the bottom wall of the refuse container 308 define an interior volume 309 in which refuse or other material may be disposed.

The compactor assembly 303 includes a compactor 306 operably coupled with an arm 304. In this embodiment, compactor 306 is a roller compactor 306 defining a cylindrical body extending between laterally opposed first end face 306A and second end face 306B. However, other compacting devices may be used in other embodiments, and where roller compactors are used, they need not be cylindrical in shape. The compactor 306 is rotatable about an axis of rotation extending parallel to the X-axis and extending perpendicularly to the right sidewall 386A and the left sidewall 386B of the open-topped container 308. Compactor 306 can be fixedly or releasably mounted on or attached to arm 304 by any suitable means familiar to those of skill in the art. In one embodiment, compactor 306 depends from a platform 340 extending laterally outward of arm 304.

Arm 304 is only partially visible in the Figures and is shown schematically for ease of illustration. In various embodiments, arm 304 can be analogous to the articulating arms used on construction equipment such as excavators and the like. Thus, arm 304 may comprise multiple hydraulically-controlled segments including a boom and dipper and may be controlled by a human operator. Of course, in other embodiments, the arm 304 may be autonomously controlled or semi-autonomously controlled and need not be hydraulically-actuated. Embodiments of the present invention are suitable for use with any type of vehicle-mounted arm.

Examples of compacting devices coupled with vehicle-mounted arms are disclosed, for example, in Great Britain Pub. App. No. GB2261832A, entitled “Method for treating waste and apparatus for use in the method”; U.S. Pat. No. 5,365,837, entitled “Apparatus for packing material in an open top container”; U.S. Pat. No. 6,739,535, entitled “Mobile trash pulverizer”; U.S. Pat. No. 7,100,500, entitled “Device for compacting waste in containers”; U.S. Pat. No. 11,400,677, entitled “Portable roller compactor”; and U.S. Pat. No. 11,839,880, entitled “Mobile trash compactor and pulverizer.” The entire contents of each of the foregoing patents and patent application are incorporated by reference herein for all purposes. Embodiments of the present invention are suitable for use with the compacting devices disclosed in any of these references, among others.

As will be appreciated, compactor 306 is variably positionable relative to the refuse container 308 and within interior volume 309 via actuation of arm 304. For example, compactor 306 is movable between a first vertical position located above the top rails 312 (e.g., where the entire compactor 306 is above the top rails 312) and a second vertical position where the compactor 306 is located at least partially below the top rails 312 so that the compactor 306 extends into the interior volume 309 of the refuse container 308. The compactor 306 also is movable at an angle relative to container 308 (or to a horizontal plane defined by top rails 312), and as such the second vertical position can be offset along the Z-axis relative to the first vertical position. As will be appreciated, compactor 306 also is movable to other positions within interior volume 309 and above refuse container 308.

In various embodiments, compactor assembly 303 comprises a frame 325 coupled directly or indirectly with arm 304, the compactor 306, and/or the structure by which compactor 306 is coupled with arm 304 (e.g., platform 340). Frame 325 may have various configurations and components in various embodiments, particularly depending on the type and shape of arm 304 and/or compactor 306 to which frame 325 may be coupled. In the illustrated embodiment, frame 325 includes at least a first post 322A, a second post 322B, one or more cross-members, a first shoe 318A, and a second shoe 318B. In the illustrated embodiment, the second post 322B, second shoe 318B, and associated cross-members are mirror opposites of first post 322A, first shoe 318A, and their associated cross-members, and thus the former are not described in detail herein. In other embodiments, frame 325 may define only a single “side” and, for example, could comprise a first post 322A, a first shoe 318A and one or more cross-members. It is also contemplated that, in some embodiments where frame 325 comprises two “sides,” the respective sides are not identical and may differ in some respects.

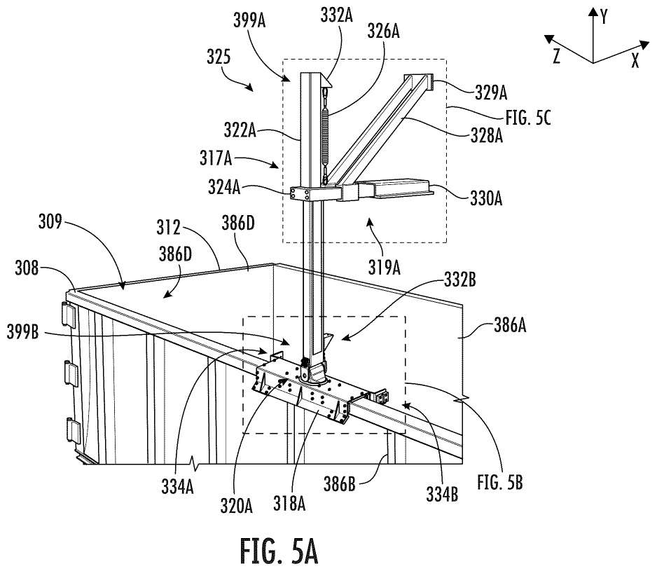

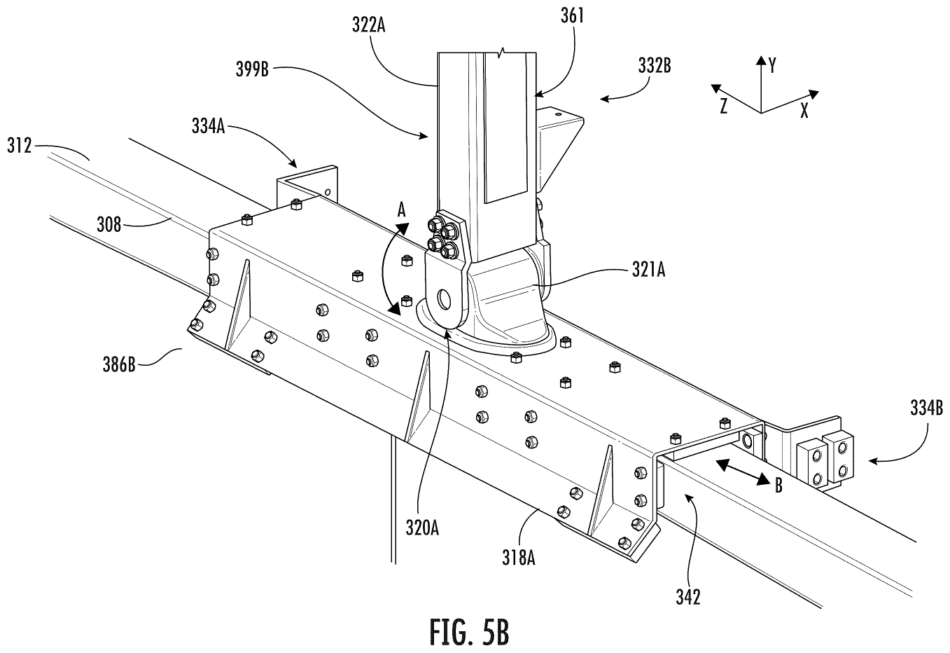

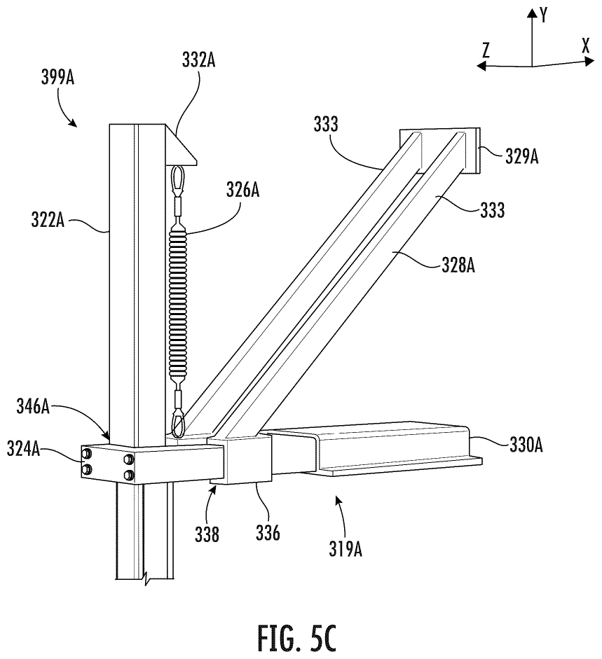

In this embodiment, the first post 322A and the second post 322B are disposed on opposing lateral sides of compactor 306 when the compactor assembly 303 is coupled with arm 304. The first post 322A defines a proximal end 399A positioned above and opposite a distal end 399B (see FIG. 5A) and a body 354 extending therebetween. The second post 322B may also have a proximal end, body, and distal end like that of the first post 322A.

In the illustrated embodiment of frame 325, the one or more cross-members include a horizontally extending cross-member 324A, a horizontally extending cross-member 324B, a diagonally extending cross-member 328A, and a diagonally extending cross-member 328B. Other embodiments may have fewer than or greater than these cross-members and such cross-members could be disposed in different orientations relative to arm 304 and/or compactor 306, again depending on the type of arm and type of compactor used and the means by which the compactor is coupled with the arm.

In this embodiment, cross members 324A and 324B extend between respective posts 322A and 322B and respective adjustable brackets 330A and 330B. Adjustable brackets 330A and 330B each can be coupled with platform 304 as described herein. Also, in this embodiment, cross-members 328A and 328B extend between arm 304 and respective cross members 324A and 324B. As described herein, in some embodiments cross-members 324A and 324B can be movable relative to cross-members 328A and 328B. Thus, cross-members 324A, 324B, 328A, and 328B move with arm 304.

Regardless of the number and configuration of cross-members in various embodiments, one or more of the cross-members preferably are movable with respect to (e.g., translatable along) the posts 322A, 322B. As described in greater detail herein, for example, cross-members 324A, 328A are configured to be movable or translatable relative to the first post 322A in response to movement of arm 304. Similarly, cross-members 324B, 328B are configured to be movable or translatable relative to the second post 322B in response to movement of arm 304. Such movement of arm 304 may include not only vertical movement but movement with a vertical component.

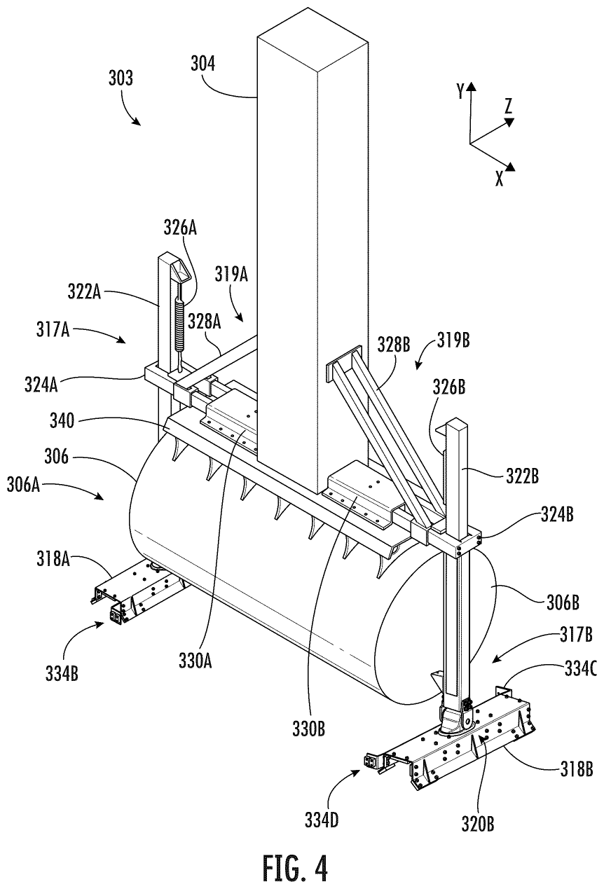

In this regard, and referring now also to FIGS. 4-7A, the horizontally extending cross member 324A in this embodiment defines an internal recess 346A configured to receive the first post 322A therein. Internal recess 346A allows the horizontally extending cross member 324A to move up and down along the first post 322A. To receive the first post 322A in the internal recess 346A, end wall 371 may be removed to provide access to the internal recess 346A. Once the first post 322A is received in the internal recess 346A, the end wall 371 may be reattached.

To facilitate low friction movement of cross-member 324A along the first post 322A, in some embodiments first post 322A can comprise one or more plates 361 positioned along the length of the first post 322A. The plates 361 may comprise, for example, plates formed from Hardox® steel or another suitable metal material having a high hardness, a high toughness, and a high ability to protect against wear and abrasion. The plates 361 can be welded onto the first post 322A in one example. Use of plates 361 may minimize the amount of maintenance required for the first post 322A and the horizontally extending cross member 324A over time.

Additionally, in the illustrated embodiment, the horizontally extending cross member 324A includes two horizontally extending bars 350 that extend along the length of the horizontally extending cross member 324A. Bearings 348 are positioned on the inner faces of the bars 350 to facilitate movement of the cross member 324A relative to the adjustable bracket 330A as described further herein. In other embodiments, cross-member 324A could comprise a single bar 350, and bearings 348 are not required.

Also in this embodiment, a diagonally extending cross-member 328A is coupled with the horizontally extending cross-member 324A. At a proximal end, for example, cross-member 328A may be welded, bolted, or otherwise attached to a length of hollow tubing 336 that defines an internal recess 338 through which a portion of cross-member 324A is received. Tubing 336 is preferably not attached to cross-member 324A to allow relative movement therebetween. As discussed herein, this allows adjustment of frame 325 to accommodate containers 308 of differing widths. The diagonally extending cross-member 328A also includes diagonally extending bars 333 in this embodiment that extend between tubing 336 and an end plate 329A at a distal end of cross-member 328A. The end plate 329 extends in a vertical plane that extends parallel to the Y-Z plane in this example, but the shape and orientation of end plate 329 can vary depending on the shape and type of arm 304 to which it is to be attached. Here, end plate 329 can be attached to the arm 304 by fasteners (e.g., bolts), by welding, or through other suitable means.

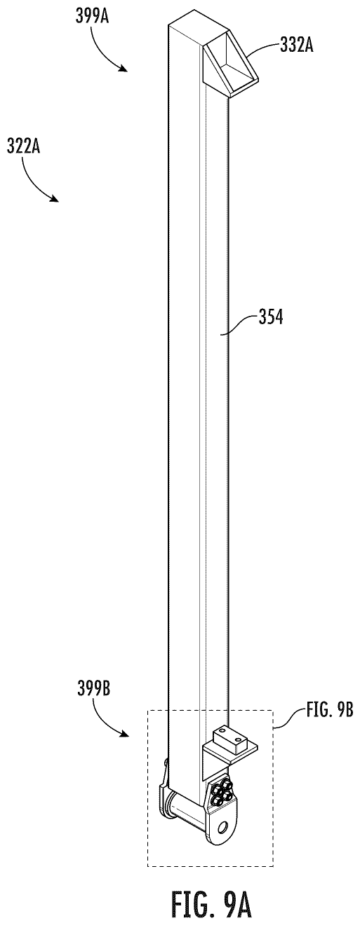

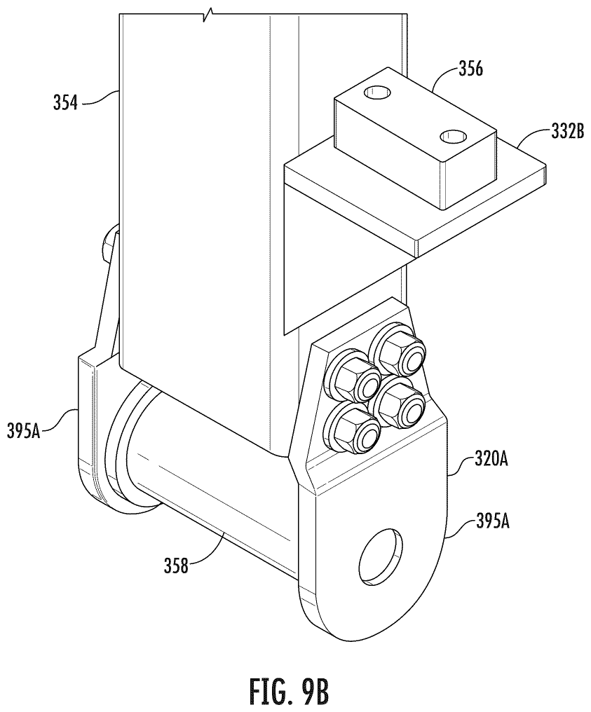

In this embodiment, frame 325 also includes springs 326A, 326B. As can be seen in FIGS. 5C and 9A, an upper end of the spring 326A is attached to a projection 332A coupled with the proximal end 399A of the first post 322A. In this embodiment, projection 332A resembles a right triangular prism and is positioned to project toward the cross-members 324A, 328A. Thus, a lower end of the spring 326A can be attached to the horizontally extending cross member 324A. Spring 326B can be attached between post 322B and cross-member 324B in a similar manner. The springs 326A, 326B can resist the downward movement of the horizontally extending cross-members 324A, 324B and bias their return upward. In other embodiments, springs 326A, 326B need not be provided at all or could instead hydraulic or pneumatic cylinders, or other suitable linear actuators, could be used.

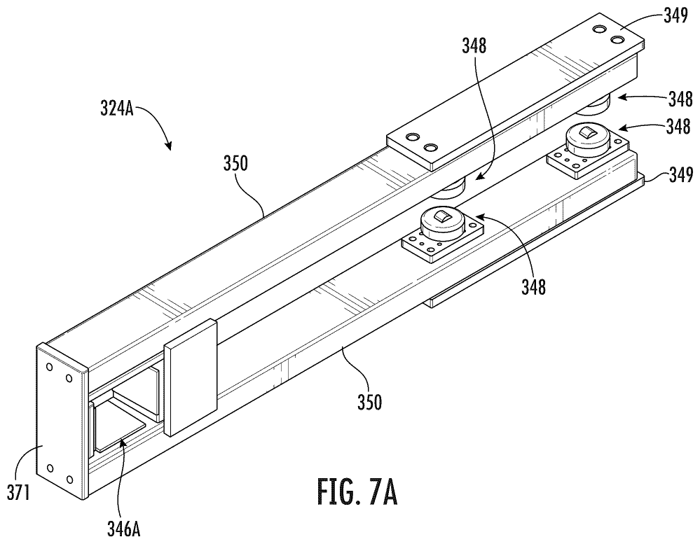

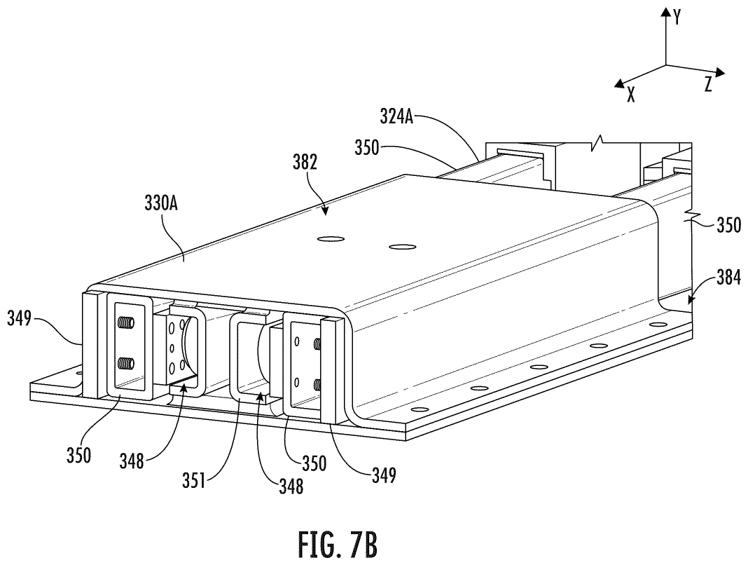

Further, as noted above, in this embodiment frame 325 can be connected to base 340 of arm 304 via adjustable bracket(s). Thereby, the frame 325 can be adjusted for use with refuse containers having different widths and/or compactors 306 of different sizes. An example such bracket 330A is shown in FIGS. 4, 5C-6C, and 7B. As best seen in FIG. 7B, bracket 330A includes an internal member 351 in this embodiment that generally defines an I-shaped cross-section. The bracket 330A is configured to receive bars 350 of the horizontally extending cross-member 324A within the bracket 330A on either side of member 351, with bearings 348 in rolling engagement with member 351. The bracket 330A may be releasably attached to the base 340 of the arm 304 via suitable apertures 384 that receive mechanical fasteners, such as bolts, but another fastening method such as welding could be used in other embodiments. As will be appreciated, cross-member 324A may be adjusted in position relative to bracket 330A to shift closer to or farther away from arm 304. In one embodiment, one or more apertures 382 may be defined in bracket 330A to receive one or more suitable fasteners (e.g., hitch pins) in order to restrict movement of the cross-member 324A relative to bracket 330A in directions parallel to the X-axis.

In other embodiments, the position of cross-member 324A could be automatically adjustable relative to bracket 330A, e.g., by the operator of a vehicle carrying arm 304 and frame 325 from the driver's cab. Further, in some embodiments, a suitable sensor (e.g., a proximity sensor) can be provided in or on brackets 330A, 330B to detect the position of brackets 330A, 330B in the X-axis direction or relative motion between brackets 330A, 330B and cross-members 324A, 324B, respectively. Those of skill in the art are familiar with suitable sensors that can be used for this purpose, including but not limited to induction sensors, magnetic sensors, and capacitive sensors. Additional detail regarding the use of certain sensors in a refuse container environment is disclosed in commonly-owned U.S. Pat. No. 9,874,464, entitled “Sensor Mount,” the entire disclosure of which is incorporated herein by reference for all purposes.

Next, shoes 318A, 318B of the frame 325 each are selectively engageable with top rails 312 of refuse container 308. Preferably, when they are so engaged, the shoes 318A, 318B are configured to move parallel to the Z-axis, as indicated by the arrowed line B in FIG. 5B, while being restricted from movement in directions parallel to the X-axis (which extends in a horizontal plane like the Z-axis in FIG. 5B). While various different configurations are contemplated in this regard, in one embodiment the shoes 318A, 318B can each define a slot 342 (see, e.g., FIGS. 5A, 6A-6B, 8A-8C) sized to receive or engage a top rail 312 of the open-topped container 308, for example for sliding engagement with the top rail 312 (see, e.g., FIG. 5B). As a result, both the first shoe 318A and the second shoe 318B can move along top rails 312 without being attached to top rails 312 or refuse container 308. In some embodiments, a sensor such as the sensors described above or disclosed in the '464 Patent could be coupled with either or both of shoes 318A, 318B to allow for position reading either as the shoes 318A, 318B move along top rail 312 in the Z-axis direction or when they come into contact with (or are about to come into contact with) an end wall of container 308.

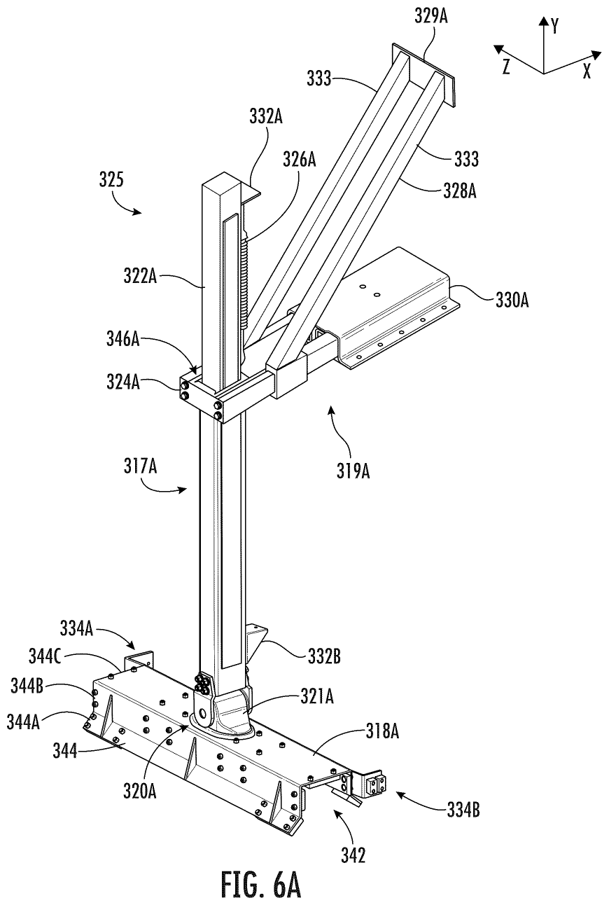

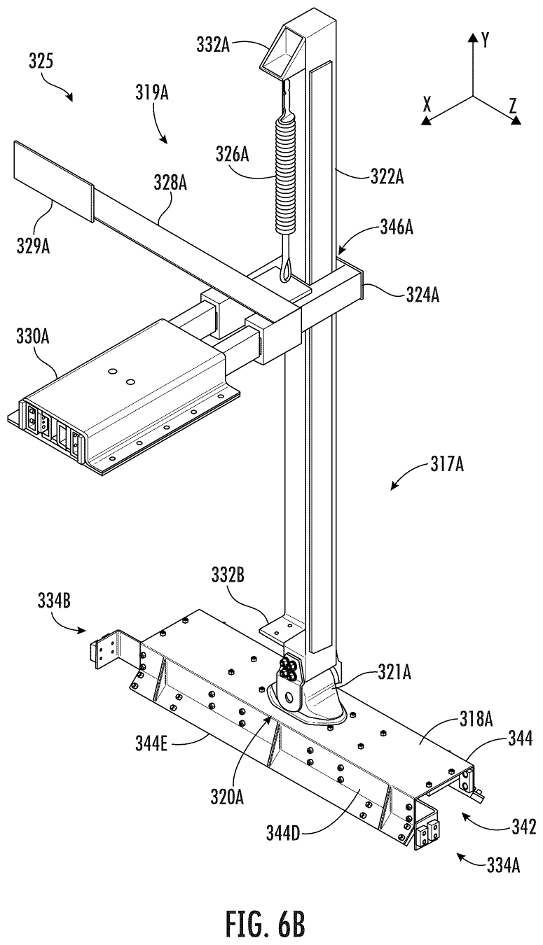

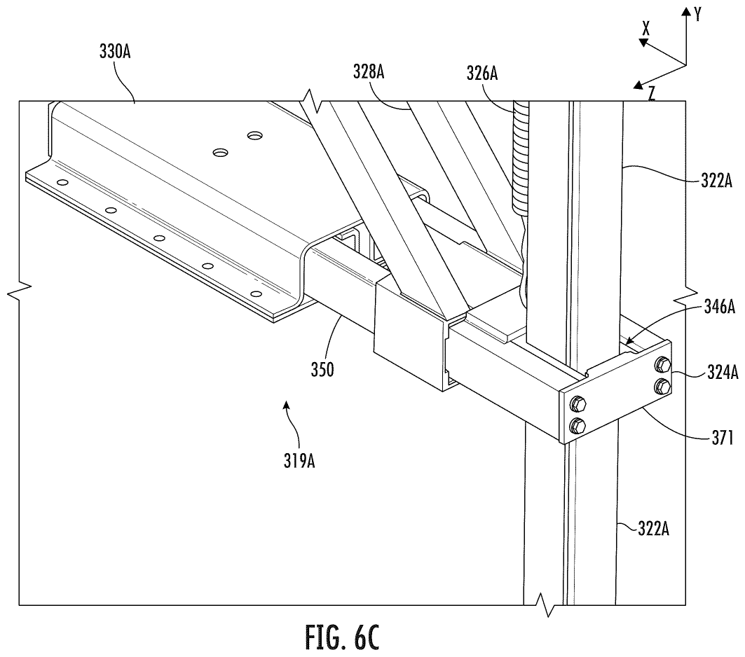

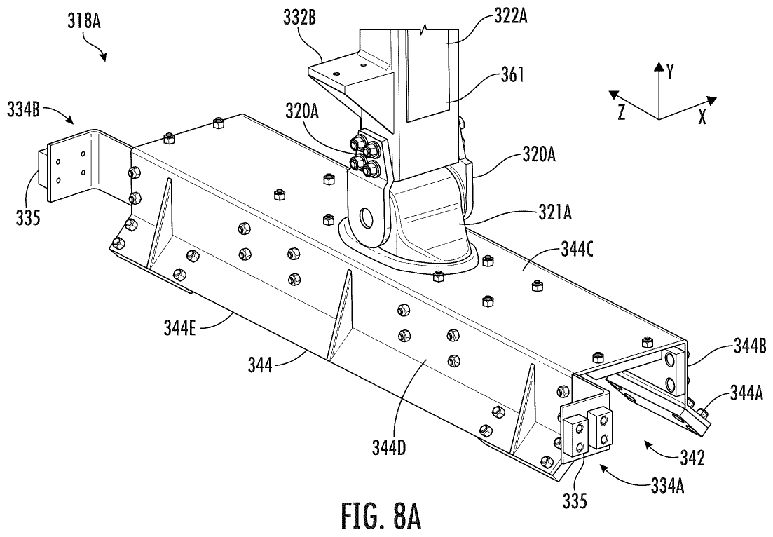

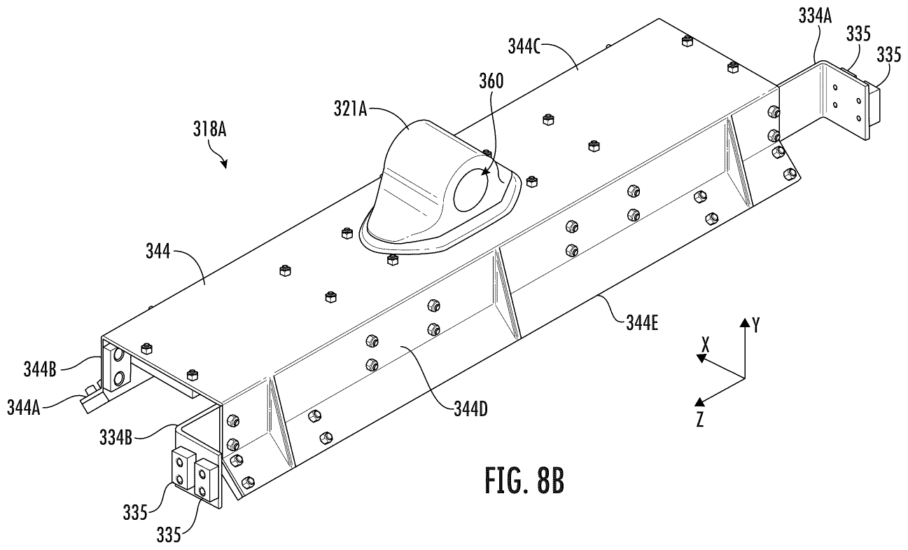

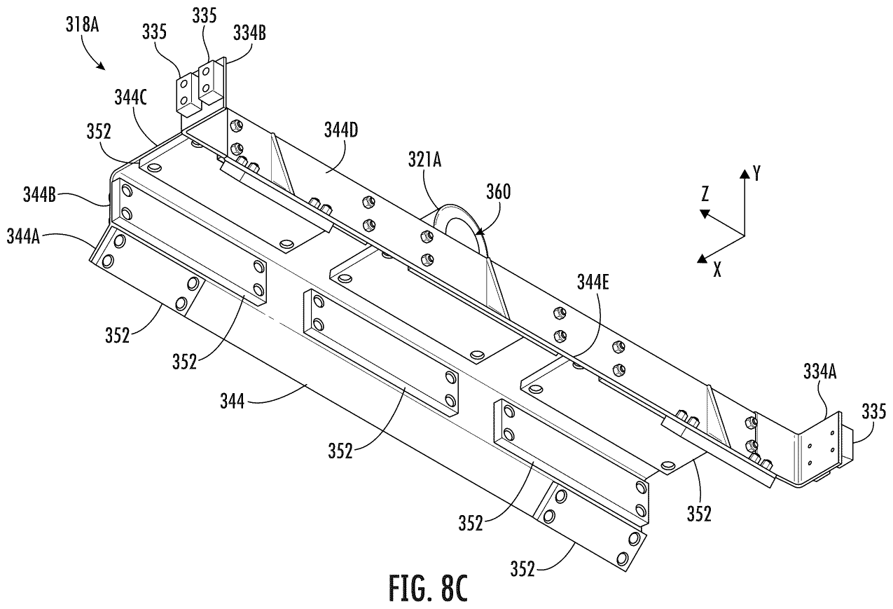

With reference to FIGS. 6A-6B and 8A-8C, in this embodiment each shoe 318A, 318B comprises a body 344. While body 344 can have various cross-sectional shapes in various embodiments, here body may be “bell-shaped” in cross section to facilitate placement on and sliding engagement with top rails 312. For example, body 344 defines a first portion 344A, a second portion 344B, a third portion 344C, a fourth portion 344D, and a fifth portion 344E. The third portion 344C forms the top surface of the body 344, and portions 344B and 344D depend from portion 344C, for example at 90-degree angles relative thereto (although this is not required). Thereby, the portions 344B-344D define the slot 342 where the top rail 312 can be received.

In the illustrated embodiment of shoe 318A, slot 342 may be oversized along the X-direction so that top rail 312 readily fits within slot 342. In some embodiments, the slot 342 may be oversized along the X-directions by about an inch or less, by about 1.5 inches or less, or by about 2 inches or less. Having a slot 342 that is oversized may allow the first shoe 318A to be used with different types of refuse containers and with refuse containers that have already experienced deformation through bowing or otherwise.

Additionally, the first portion 344A is attached to the second portion 344B, and the fifth portion 344E is attached to the fourth portion 344D. To provide an enlarged opening below the slot 342 in this embodiment, portions 344A and 344E flare laterally outward of portions 344B and 344D, respectively. In other words, portions 344A and 344E are disposed at oblique angles relative to portions 344B and 344D. As the first shoe 318A is lowered down to the top rail 312, the first portion 344A and the fifth portion 344E may help to align the first shoe 318A with top rail 312 so that top rail 312 is urged into slot 342.

As explained above, cross-members 324A, 324B, 328A, 328B are coupled to and move with arm 304, and they also are coupled with posts 322A, 322B and can translate therealong. While these components of frame 325 can move relative to one another in response to movement of arm 304 during use, shoes 318A, 318B will be positioned on or engaged with a refuse container. Thus, posts 322A, 322B are pivotably attached to shoes 318A, 318B in this embodiment to allow shoes 318A, 318B to remain in position relative to the refuse container while also allowing movement of posts 322A, 322B (and cross-members 324A, 324B, 328A, 328B) in response to movement of arm 304 in an angularly upward or downward motion. In particular, the first shoe 318A is pivotably coupled with the first post 322A at a distal end 399B of the first post 322A, and second shoe 318B is pivotably coupled with the second post 322B at a distal end of the second post 322B.

For example, and referring also to FIGS. 9A and 9B, a bracket 320A can be attached to a distal end 399B of the first post 322A. In this embodiment, bracket 320A comprises two laterally opposing end portions 395A and a pivot axle 358 that extends between end portions 395A. A similar bracket 320B can be disposed at the distal end of post 322B. Brackets 320A, 320B are configured for rotational coupling with shoes 318A, 318B. For instance, as shown in FIG. 8B, the first shoe 318A can include a hub 321A defining an aperture 360 therethrough sized to receive pivot axle 358. As shown, the end portions 395A can be attached to the first post 322A using mechanical fasteners (e.g., bolts or the like) so that the connection between bracket 320A and hub 321A can be made.

The connections between the posts 322A, 322B and their respective shoes 318A, 318B allow the posts 322A, 322B to pivot in generally vertical planes as indicated by the arrowed line A in FIG. 5B. For example, the connection between the first post 322A and the first shoe 318A allows the first post 322A to pivot relative to the first shoe 318A within a plane extending parallel to the left sidewall 386B, which generally extends parallel to the Y-Z plane. Similarly, the connection between the second post 322B and the second shoe 318B allows the second post 322B to pivot relative to the second shoe 318B within a plane extending parallel to the right sidewall 386A, which generally extends parallel to the Y-Z plane.

Next, in various embodiments, compactor assembly 303 can comprise one or more stop features that limit movement of one or more components of frame 325 in one or more directions. In this regard, and referring to FIGS. 5A-5B, first post 322A can include or define a stop 332B at the distal end 399B of body 354. The stop 332B can include one or more bumpers 356 that can be formed of an elastic material (e.g., rubber). As will be appreciated, stop 332B limits or restrains movement horizontally extending cross-member 324A along first post 322A. The position of stop 332B along post 322A can be varied, as needed or desired, and may be selected, for example, based on balancing the considerations of compacting as much material as possible and protecting against over-compaction. A stop similar to stop 332B may be attached to a distal end of the second post 322B.

One or more stop features also can be provided on either or both of shoes 318A and 318B. In the embodiment shown in FIGS. 5A-5B and 8A, for example, first shoe 318A includes a first stop 334A on a first side and a second stop 334B on a second side opposite the first side. Similarly, the second shoe 318B includes a third stop 334C on a first side and a second stop 334D on a second side opposite the first side. As the first shoe 318A slides along the top rail 312 in the positive Z-direction and approaches the end wall 386D, the first stop 334A is positioned so that it will contact end wall 386D, resisting further movement of the first shoe 318A (and, correspondingly, frame assembly 325) in the positive Z-direction. Similarly, as the first shoe 318A slides along the top rail 312 in the negative Z-direction and approaches end wall 386C, the second stop 334B is positioned so that it will contact end wall 386C, resisting further movement of the first shoe 318A (and, correspondingly, frame assembly 325) in the negative Z-direction. The stops 334A, 334B may each include bumpers 335 analogous to bumpers 356 described above (see FIG. 8A). The stops 334C, 334D on the second shoe 318B may be similar to the stops 334A, 334B and may operate in a similar manner.

Further, in various embodiments, one or more components of frame 325 can be provided with one or more sheets of friction-reducing material. Those skilled in the art are familiar with and can select suitable friction-reducing sheets for use in applications of the present invention, but in various embodiments the friction-reducing sheets can be formed, for example, of polyethylene, nylon-6, and copolymers thereof. In this regard, shoes 318A, 318B may each include such sheets 352 in the area of slot 342 to reduce the friction between top rail 312 and shoes 318A, 318B. In one embodiment, the first shoe 318A includes two sheets 352 are positioned on each of the first portion 344A and the fifth portion 344E, and three sheets 352 are positioned on each of the second portion 344B, the third portion 344C, and the fourth portion 344D. In some embodiments, only the sheets 352 may be in contact with the top rail 312 so that the body of the first shoe 318A does not come in contact with the top rail 312 in any way. Sheets 352 are removable and replaceable and can be attached to shoes 318A, 318B using suitable fasteners, for instance. Analogous sheets 352 also could be positioned in the internal recess 346A in some embodiments to reduce the amount of friction between the horizontally extending cross-member 324A and the first post 322A. Likewise, as best seen in FIGS. 7A-7B, sheets 349 can be positioned at the outer faces of the bars 350 to reduce friction between bars 350 and brackets 330A, 330B.

In accordance with another embodiment, frame 325 comprises one or more masts 317A, 317B and one or more yoke(s) 319A, 319B that are moveably coupled to the mast(s). Masts 317A, 317B each extend between a proximal end and a distal end, and the yokes 319A, 319B may be attached to the base 340 of the arm 304 so that compactor 306 is disposed beneath the yokes 319A, 319B. As the arm 304 is moved, the yokes 319A, 319B are translatable along the masts 317A, 317B from a position proximate the mast proximal ends to a position proximate the mast distal ends. The first post 322A in the mast 317A may define a longitudinal axis, and the second post 322B in the mast 317B may also define a longitudinal axis. The longitudinal axis for the first post 322A and the longitudinal axis for the second post 322B may each extend parallel to the Y-axis.

Additionally, the masts 317A, 317B can be pivotable relative to the refuse container 308 about a pivot axis extending parallel with the axis of rotation of compactor 306 and parallel to the X-axis in FIGS. 3A-3B. The masts 317A, 317B may each be coupled with a shoe (e.g., analogous to shoes 318A, 318B described herein) at a respective distal end of the masts, and the masts 317A, 317B may be pivotable relative to their respective shoes in a vertical plane containing a respective top rail of the open-topped container 308. For example, the mast 317A can be coupled with the first shoe 318A at the distal end 399B of the mast 317A, and the mast 317A may be pivotable relative to the first shoe 318A in a vertical plane extending parallel to the Y-Z plane and to the left side wall 386B. This vertical plane may contain or intersect with a respective top rail 312 of the open-topped container 308. Mast 317B can similarly be pivotable relative to the second shoe 318B in a vertical plane extending parallel to the Y-Z plane and parallel to the right side wall 386A. In other words, the planes in which masts 317A, 317B move intersect their respective shoes 318A, 318B and the respective longitudinal axes of masts 317A, 317B.

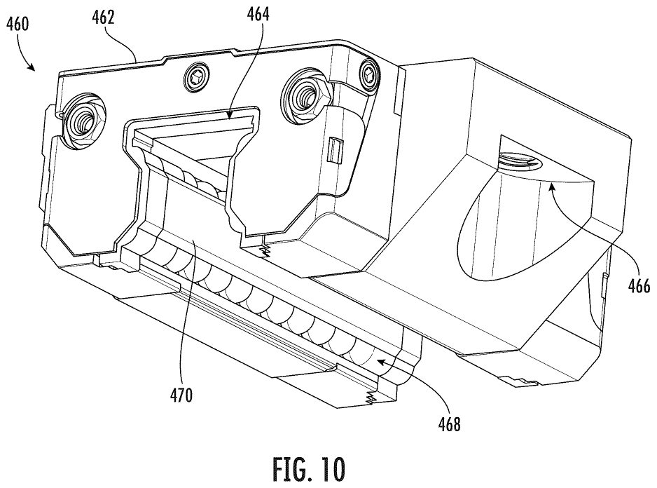

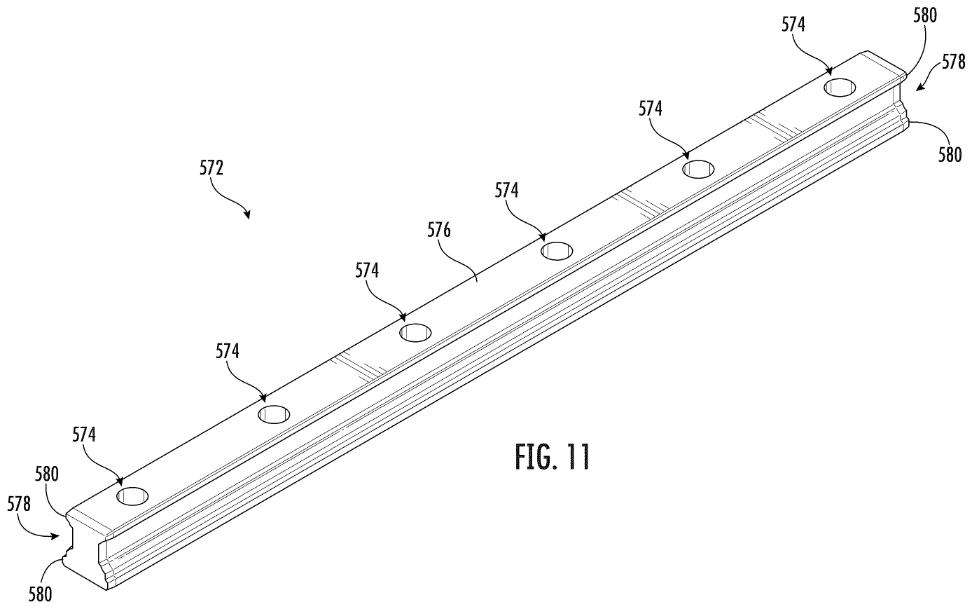

Next, as described above with reference to FIGS. 4, 5C-6C, and 7B, element(s) of frame 325 can be connected to an arm 304 via one or more adjustable bracket(s). Again, this can allow the frame 325 to be adjusted for use with refuse containers having different widths and/or compactors 306 of different sizes. One example such bracket 330A including internal member 351 that cooperates with bars 350 and bearings 348 of cross-members 324A, 324B is shown in FIGS. 4, 5C-6C, and 7B. But in another embodiment, a carriage 460 as illustrated in FIG. 10 could be used either within bracket 330A or as a standalone unit, and carriage 460 can cooperate with a carriage bar 572, as illustrated in FIG. 11, that can be a part of, or used as a substitute for, cross-members 324A, 324B. In this regard, carriage 460 defines a body 462. The body 462 defines an internal recess 464 therein, and this internal recess 464 generally defines an I-shape. Extended portions 470 extend into the internal recess 464 from the left side and the right side of the internal recess 464. Thus, the internal recess 464 has an enlarged width at the top of the internal recess 464, a smaller width at the portions of the internal recess 464 proximate to the extended portions 470, and an enlarged width at the bottom of the internal recess 464. Above and below the extended portions, openings may be provided that extend along the length of the internal recess 464. The openings may expose bearings 468 therein. Additionally, holes 466 are provided on the left side and the right side of the body 462. The holes 466 extend vertically, and the holes 466 may be threaded so that they may easily engage a fastener such as a screw. The fastener may be used to attach the carriage 460 to a base of an arm or to a bracket 330A, but the carriage 460 also may be connected to other components.

As shown in FIG. 11, carriage bar 572 includes a body 576 and holes 574 extend through the body 576. The holes 574 are vertically extending holes in FIG. 11, but different holes may be used in other embodiments. The holes 574 may be configured to receive fasteners in some embodiments, and the holes 574 may optionally be threaded holes. Additionally, the carriage bar 572 generally defines an I-shaped cross-section in this embodiment, with the carriage bar 572 having an extended portion 580 extending horizontally outwardly at the top and bottom of the carriage bar 572. The carriage bar 572 also defines a recessed portion 578 between the extended portion 580 on the left and right sides of the carriage bar 572.

As will be appreciated, carriage 460 is configured to receive the carriage bar 572 within the internal recess 464. The shape of the internal recess 464 is similar to the shape of the carriage bar 572 so that the carriage bar 572 may be easily received in the internal recess 464. For example, the recessed portions 578 of the carriage bar 572 may be positioned proximate to the extended portions 470 of the carriage 460, and the extended portions 470 of the carriage 460 may come in contact with the extended portions 580 of the carriage bar 572 to prevent vertical movement of the carriage bar 572. However, even when the carriage bar 572 is received in the internal recess 464, the carriage bar 572 may move horizontally in a direction parallel to a longitudinal axis of the carriage bar 572, and the carriage bar 572 may engage with the bearings 468 as the carriage bar 572 moves in this manner. To remove the carriage bar 572 from the internal recess 464, the carriage bar 572 may be moved in a direction parallel to the longitudinal axis of the carriage bar 572. While only one carriage 460 and one carriage bar 572 are illustrated in FIGS. 10 and 11, it should be understood that a plurality of carriages 460 and carriage bars 572 may be used in some embodiments. Additionally, while the carriage 460 is positioned so that the carriage bar 572 moves horizontally when the carriage bar 572 shifts within the internal recess 464, the carriage 460 and the carriage bar 572 may be oriented in other ways (e.g., so that the carriage bar 572 shifts vertically).

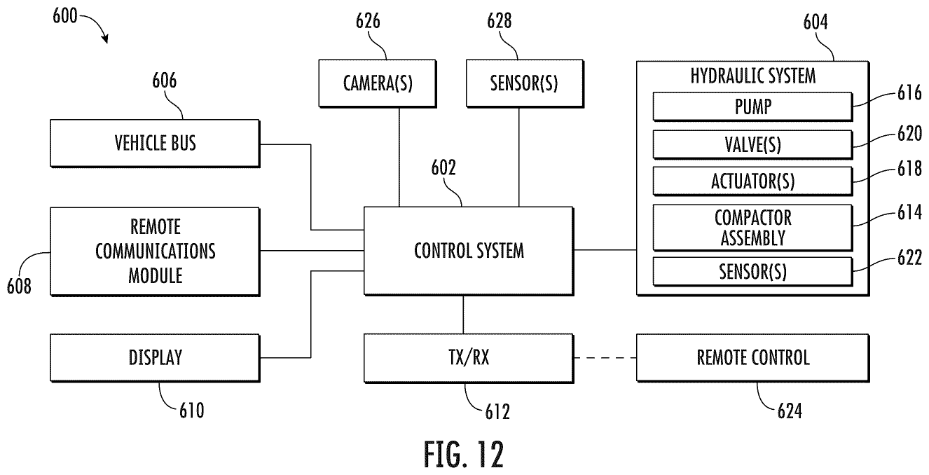

FIG. 12 is a block diagram of a system 600 that can be used to operate a vehicle or arm carrying a compactor assembly according to an embodiment of the present invention. For example, system 600 may be used with any of the systems described above (e.g., system 301) and/or with arms carrying such systems. In general, system 600 comprises a control system 602 that interfaces with various vehicle components. For example, control system 602 is in operative electronic communication with a hydraulic system 604, a vehicle bus 606, a remote communications module 608, and a display device 610. In some embodiments, system 600 may also comprise a transceiver 612 to facilitate remote, wireless operation of any of the components of system 600.

Control system 602 may be any suitable electronics with associated memory and software programs running thereon whether referred to as a processor, microprocessor, controller, control module, microcontroller, or the like. In a preferred embodiment, control system 602 may be comparable to the mobile automation control modules for hydraulic systems offered by Flodraulic Group, Inc. of Greenfield, Ind. under the trademark CANTROL™. Control system 602 preferably comprises the hardware and software necessary to operate various aspects of system 600 as described herein.

The memory of control system 602 may be any suitable memory or computer-readable medium as long as it is capable of being accessed by the control system, including random access memory (RAM), read-only memory (ROM), erasable programmable ROM (EPROM), or electrically EPROM (EEPROM), CD-ROM, DVD, or other optical disk storage, solid-state drive (SSD), magnetic disc storage, including floppy or hard drives, any type of suitable non-volatile memories, such as secure digital (SD), flash memory, memory stick, or any other medium that may be used to carry or store computer program code in the form of computer-executable programs, instructions, or data. Control system 602 may also include a portion of memory accessible only to control system 602.

Hydraulic system 604 preferably comprises components used to actuate and control an a compactor assembly 614, including an arm analogous to arm 304 described above. In this regard, hydraulic system 604 may comprise a flow path along which a pump 616 (e.g., a hydraulic gear pump coupled with a shaft turned by the vehicle's engine) may pump hydraulic fluid to and from one or more actuators 618, as is well known. The actuator(s) 618 may be provided in the form of one or more lift mechanisms such, and the actuator(s) 618 may be linear actuators in some embodiments. One or more valves 620 are preferably located along the flow path between the pump 616 and the actuator(s) 618. In particular, valves 620 may be proportional valves located in a valve group coupled with the vehicle's chassis, and each valve 620 may comprise one or more spools, the movement of which controls the flow of a hydraulic fluid, such as oil, through valves 620. In a presently preferred embodiment, and in contrast to prior art air-over-hydraulic systems, valves 620 may be actuated electrically, such as by a proportional electrical actuator, by control system 602. For example, the proportional electrical actuator may comprise a solenoid. In one embodiment, valves 620 may be comparable to the model PVG 32 and PVG 600 proportional valves and actuators offered by Sauer Danfoss Company of Ames, Iowa. It will be appreciated that actuation of valves 620 occurs more rapidly via electrical signals than in response to pneumatic signals. Additional actuator(s) 618 can be configured to move the adjustable bracket 330A (see FIG. 7B) relative to other components, but actuator(s) 618 may be configured to adjust the positioning of other components relative to each other. While actuator(s) 618 may be provided within the hydraulic system 604, the actuator(s) 618 may be provided at other locations within the system 600 in other embodiments.

Hydraulic system 604 may further comprise one or more sensors 622 in operative electronic communication with control system 602. In this regard, sensors 622 may be position sensors operative to transmit to control system 602 information representative of the extension or retraction of actuator(s) 618 or the movement of a component of a compactor assembly 614 and/or its associated arm. In addition or in the alternative, sensors 622 may be pressure sensors that transmit to control system 602 information representative of the pressure of hydraulic fluid in actuator(s) 618. Those of skill in the art are familiar with suitable sensors 622 for this purpose. Additional information regarding hydraulic systems, circuits, and sensors for compactor assemblies is provided in U.S. Pat. No. 9,874,464 to Sedory; U.S. Pat. No. 8,297,904 to Schroeder; U.S. Pat. No. 6,648,576 to Duell et al.; and U.S. Pat. No. 5,088,875 to Galbreath et al. and in U.S. Pre-Grant Pub. Nos. 2009/0025378 to Laumer et al. and 2006/0285952 to Galbreath et al., the entire disclosures of each of which are incorporated by reference herein for all purposes. Sensors 622 may be positioned in various locations. For example, one or more sensors 622 may be positioned inside of an adjustable bracket 330A (see FIG. 7B) or at another location to allow for reading of a position in a Y-direction. One or more sensors 622 may be positioned proximate to an end of a respective shoe to allow for reading of a position in an X-direction.

The control system 602 may be configured to control various devices in an automated manner. For example, the control system 602 may control components within system 301 or other components within system 600. In some embodiments, the control system 602 may receive inputs from a driver in a cab of a vehicle, and the control system 602 may adjust the operation of components within the system 600 or within another system based on the inputs from the driver.

While the sensors 622 are provided as part of the hydraulic system 604, other similar sensor(s) 628 may be provided at other locations in the system 600. As described above, a sensor(s) 628 (e.g., a proximity sensor) can be provided in or on various components described herein to detect the position of these components relative to each other. For example, a sensor can be provided on brackets 330A, 330B to detect the position of brackets 330A, 330B in the X-axis direction or relative motion between brackets 330A, 330B and cross-members 324A, 324B, respectively.

In some embodiments, one or more cameras 626 may be provided at various locations in the system 600 to effectively provide a vision system that enables better control of components. For example, the camera(s) 626 may be coupled with a post 322A, 322B or with another portion of frame 325. The camera(s) 626 may be in electronic communication with the control system 602. The camera(s) 626 may be used to provide a video feed that may be made visible to a driver in the cab of the vehicle, and the driver may use the video feed to gain a better understanding of the position of relative components. This may enable the driver to more effectively adjust the position of the frame 325, the arm 304, and/or other components. However, in some embodiments, the video feeds from the camera(s) 626 may be used for other purposes, such as to automatically adjust the position of one or more components, to generate other alerts, or to generate other data.

Those of skill in the art are familiar with communications between electronic modules internal to vehicles, such as an engine control unit, transmission control unit, and the like. In this regard, vehicle bus 606 may comprise a communications network internal to the vehicle with which control system 602 is associated for the speedy and reliable exchange of data between vehicle components. Any suitable communications protocol may be used on bus 606, such as Controller Area Network (CAN) and Local Interconnect Network (LIN), among many others. In a preferred embodiment, the protocol may be the Society of Automotive Engineers (SAE) J1939 protocol used for commercial vehicles. Control system 602 may preferably interface with vehicle bus 606 to receive data from and communicate with the other electronic components or nodes located along vehicle bus 606.

As noted above, control system 602 may also be in electronic communication with remote communications module 608 in some embodiments. Remote communications module 608 is preferably operative to transmit diagnostic and/or telematics information regarding the vehicle with which it is associated, including health information regarding the hydraulic system, usage information, and location information. In that regard, remote communications module 608 preferably comprises a wireless radio suitable for transmitting such information to a remote computing device using any suitable communications standard, including but not limited to the IEEE 802.11, 3G, 4G, or LTE standards. Thus, an operator using the remote computing device may remotely monitor health-and usage-related information for the vehicle. Remote communications module 608 may also comprise a satellite navigation receiver or antenna operative to receive signals sent from any multiple-satellite based positioning system, such as GPS, GLONASS, and GALILEO, among others. In one preferred embodiment, remote communications module 608 may be configured to receive signals from GPS satellites, based on which module 608 may determine its precise location (e.g., in longitude and latitude or another location format) and transmit this information to a remote computing device. In one embodiment, the information communicated by and to remote communications module 608 and between remote communications module 608 and control system 602 may be similar to the information communicated in the remote monitoring system offered by the Flodraulic Group under the trademark CANNECT.

Display device 610 may be any suitable portable computing device known to those of skill in the art for displaying a graphical user interface, such as but not limited to computer monitors, tablet computers, laptops, and cell phones. Display device 610 is preferably in wired or wireless electronic communication with control system 602. In particular, display device 610 may comprise a processor and memory configured to generate a graphical user interface from which an operator of a vehicle may remotely control various aspects of system 600. In one embodiment, an operator may use an input device associated with display device 610 to send commands to control system 602, and in another embodiment, display device 610 may comprise a touchscreen. In any event, an operator may preferably use display device 610 to operate compactor assembly 614 as described herein.

As noted above, in some embodiments, system 600 may comprise a transceiver 612 to enable an operator to remotely actuate the vehicle compactor assembly. Those of skill in the art will appreciate, however, that system 600 need not comprise a remote actuation feature in all embodiments. In this regard, transceiver 612 may comprise any transceiver known to those of skill in the art that is suitable for wireless communications with a remote control unit 624. In one embodiment, transceiver 612 may comprise a wireless radio operative to communicate with remote control 624 using radio frequency signals with wavelengths in the ISM radio bands, though this is not required in all embodiments. In some embodiments, wireless communications may be implemented using a suitable short-range communications protocol, such as NFC, Bluetooth Low-Energy (also known as Bluetooth Smart), Peanut, Zigbee, Wi-Fi, or the like, though any suitable wireless communication protocol may be used with embodiments of the present invention. It will be appreciated that the permissible distance between transceiver 612 and remote control 624 will depend on the type of wireless communications used or the wireless communication standard implemented with transceiver 612 and the signal strength of the transceiver 612, among other factors. Additionally, in some embodiments, transceiver 612 may communicate with a remote control 624 via infrared signals.

Remote control 624 may preferably be a portable, handheld device configured for wireless communication with transceiver 612 as described above. In one embodiment, remote control 624 comprises buttons on a front surface thereof along with a display, which may be an LCD or LED display, for example. As needed or desired, remote control 624 may also comprise one or more buttons on either side thereof.

It will be appreciated that the number, configuration, and function of buttons on remote control 624 may vary, depending on the needs of the operator and the type of compactor assembly to be controlled. In the illustrated embodiment, for example, remote control 624 may be associated with compactor assembly 614 and or the arm thereof, and thus buttons on the front surface may be configured to cause movement of the arm and/or portions thereof in various directions.

When a user actuates one of the buttons, remote control 624 can send a signal to control system 602 (via transceiver 612) indicating that the function associated with the button should occur. Control system 602 may then actuate one or more valves 620 and/or pump 616 to cause that function to occur. In some embodiments, the length of time a function occurs may correspond to the length of time an operator depresses one of buttons. When the control system 602 no longer receives a signal from remote control 624, control system 602 will stop performance of the requested function. In other embodiments, after the operator has depressed a particular button, control system 602 may cause the corresponding function to occur continuously, and regardless of whether the operator is still depressing the button, until the function is complete or until the operator depresses the same button for a second time. Further, in some embodiments, when a button is depressed, further presses of the same button may adjust the speed at which the function activated by that button occurs. For example, in the case of “arm up” or “arm down” functions, successive pressing on the corresponding buttons may cause the speed of movement for the arms to increase a predetermined amount, up to a maximum speed. Those of skill in the art will appreciate, however, that buttons may be configured for different or additional functionality in other embodiments.

### CONCLUSION

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. An assembly for compacting material disposed within an open-topped container, the open-topped container comprising a left side wall and a right side wall and a pair of top rails respectively extending along the left side wall and the right side wall, the assembly comprising:
a roller compactor coupled with an arm, the roller compactor rotatable about an axis of rotation extending perpendicularly to the left side wall and the right side wall of the open-topped container, the roller compactor positionable relative to the open-topped container between a first vertical position located above the pair of top rails and a second vertical position, wherein, at the second vertical position, the roller compactor is located at least partially below the pair of top rails and within an interior volume of the open-topped container; and
a frame coupled with the arm, the frame comprising:
a first post and a second post disposed on opposing lateral sides of the roller compactor, the first post and the second post each defining a proximal end and a distal end;
a first shoe pivotably coupled with the distal end of the first post and a second shoe pivotably coupled with the distal end of the second post, wherein the first shoe and the second shoe each define a slot sized for sliding engagement with a respective top rail of the pair of top rails of the open-topped container; and
at least one first cross-member extending between the first post and the arm and at least one second cross-member extending between the second post and the arm;
wherein the at least one first cross-member and the at least one second cross-member are movable relative to the first post and the second post in response to movement of the roller compactor between the first vertical position and the second vertical position.

2. The assembly of claim 1, wherein the roller compactor is positionable relative to the open-topped container at a third vertical position that is angularly offset from the first vertical position.

3. The assembly of claim 1, wherein the roller compactor defines a cylindrical body extending between a pair of laterally opposed faces.

4. The assembly of claim 3, further comprising:
a first spring disposed between the proximal end of the first post and the at least one first cross-member; and
a second spring disposed between the proximal end of the second post and the at least one second cross-member.

5. The assembly of claim 3, wherein the first post is pivotable relative to the first shoe within a plane extending parallel to the left side wall, and the second post is pivotable relative to the second shoe within a plane extending parallel to the right side wall.

6. The assembly of claim 1, wherein when the first shoe and the second shoe are engagement with the pair of top rails, the roller compactor is not laterally moveable.

7. The assembly of claim 6, wherein the first shoe further comprises at least one stop to limit movement of the frame and the roller compactor in a direction parallel to the pair of top rails.

8. The assembly of claim 1, wherein the first shoe comprises a body and the first shoe comprises at least one sheet positioned in the slot, the sheet positioned to contact a top rail of the pair of top rails.

9. The assembly of claim 8, wherein the sheet comprises polyethylene, nylon-6, or a copolymer thereof.

10. The assembly of claim 1, wherein the shoe comprises at least one position sensor.

11. The assembly of claim 1, wherein the first post includes a stop to limit movement of the roller compactor towards the open-topped container.

12. The assembly of claim 1, wherein the first post and the second post are laterally adjustable relative to the arm.

13. An assembly for compacting material disposed within an open-topped container, the open-topped container comprising a left side wall and a right side wall and a pair of top rails respectively extending along the left side wall and right side wall, the assembly comprising:
a roller compactor coupled with an arm, the roller compactor rotatable about an axis of rotation extending perpendicularly to the left side wall and the right side wall of the open-topped container;
a pair of masts each defining a proximal end and a distal end, wherein the distal end of each mast is respectively engageable with a top rail of the open-topped container; and
at least one yoke attached to the arm and movably coupled with the pair of masts;
wherein, in response to movement of the arm, the at least one yoke is translatable along the pair of masts from a position proximate the mast proximal ends to a position proximate the mast distal ends and the pair of masts are pivotable relative to the open-topped container about a pivot axis extending parallel with the axis of rotation.

14. The assembly of claim 13, wherein the arm is hydraulically powered.

15. The assembly of claim 13, wherein the roller compactor is disposed beneath the at least one yoke.

16. The assembly of claim 13, wherein a first mast of the pair of masts is coupled with a shoe at a respective distal end of the first mast, and the first mast is pivotable relative to the shoe in a vertical plane containing a respective top rail of the open-topped container.

17. An assembly for compacting material disposed within an open-topped container, the open-topped container comprising a first top rail and a second top rail respectively extending along a pair of laterally opposed side walls of the open-topped container, the assembly comprising:
a roller compactor coupled with an arm, the roller compactor rotatable about an axis of rotation extending perpendicularly to the side walls of the open-topped container;
a frame assembly coupled with the arm, the frame assembly comprising:
a first support member defining a proximal end, a distal end, and a longitudinal axis;
a second support member defining a proximal end, a distal end, and a longitudinal axis;
a first shoe pivotably coupled with the distal end of the first support member; and
a second shoe pivotably coupled with the distal end of the second support member;
wherein the first shoe is selectively engageable with and slidable along the first top rail of the open-topped container and the second shoe is selectively engageable with and slidable along the second top rail of the open-topped container;
wherein the first support member is pivotable relative to the first shoe along a plane intersecting the first shoe and the longitudinal axis of the first support member, and the second support member is pivotable relative to the second shoe along a plane intersecting the second shoe and the longitudinal axis of the second support member.

18. The assembly of claim 17, wherein the first support member is pivotable relative to the first shoe within a first plane extending parallel to a first side wall of the pair of laterally opposed side walls, and the second support member is pivotable relative to the second shoe within a second plane extending parallel to a second side wall of the pair of laterally opposed side walls.

19. The assembly of claim 17, wherein the arm is mounted to a vehicle, the vehicle having a control system.

20. The assembly of claim 19, further comprising a camera coupled with the arm, the camera in electronic communication with the control system.

21. An assembly for use with a roller compactor for compacting material within an open-topped container, the open-topped container comprising a first top rail and a second top rail respectively extending along a pair of laterally opposed side walls of the open-topped container, the roller compactor coupled with an arm and rotatable about an axis of rotation extending perpendicularly to the laterally opposed side walls of the open-topped container, the assembly comprising:
a first support member defining a proximal end, a distal end, and a longitudinal axis, the first support member proximal end attachable to the arm;
a second support member defining a proximal end, a distal end, and a longitudinal axis, the second support member proximal end attachable to the arm;
a first shoe pivotably coupled with the distal end of the first support member; and
a second shoe pivotably coupled with the distal end of the second support member;
wherein the first shoe and the second shoe each are selectively engageable with a respective first top rail or a second top rail of the open-topped container;
wherein, when the first support member and the second support member are attached to the arm, the first shoe is disposed on the first rail of the open-topped container and the second shoe is disposed on the second top rail of the open-topped container, and the arm is moved relative to the open-topped container,
the first shoe is slidable along the first top rail and the second shoe is slidable along the second top rail, the first support member is pivotable relative to the first shoe along a first plane intersecting the first top rail and the first support member longitudinal axis, and the second support member is pivotable relative to the second shoe along a second plane intersecting the second top rail and the second support member longitudinal axis.
